(19) United States
(12) Patent Application Publication
(10) Pub. No.: US 2017/0287664 A1
(43) Pub. Date: Oct. 5, 2017

(54) THERMALLY ACTIVATED SWITCH

(71) Applicant: Intel Corporation, Santa Clara, CA (US)

(72) Inventors: Adel A. Elsherbini, Chandler, AZ (US); Feras Eid, Chandler, AZ (US); John J. Beatty, Chandler, AZ (US)

(73) Assignee: Intel Corporation, Santa Clara, CA (US)

(21) Appl. No.: 15/089,213

(22) Filed: Apr. 1, 2016

(51) Int. Cl. H01H 37/46; H01H 37/04; H01H 37/64; H01H 37/72

(52) U.S. Cl. CPC H01H 37/46; H01H 37/72; H01H 37/04; H01H 37/64

(57) ABSTRACT

Thermal switch technology is disclosed. In one example, a thermally activated switch can include an electronic substrate base, and first and second electrical contacts coupled to the electronic substrate base. The first and second electrical contacts can be movable relative to one another due to thermal expansion or contraction of a material to facilitate contact or separation of the first and second electrical contacts.

### TECHNICAL FIELD

Embodiments described herein relate generally to mitigation of negative thermal effects in electronic devices, and more particularly to thermal sensors and switches in such devices.

### BACKGROUND

Electronic devices include certain components that can heat up during use, with temperatures that can sometimes exceed safe levels for electronic components and/or operators of electronic devices. One particularly concerning condition is “thermal runaway”, which can occur when a CPU is doing heavy processing and as a result is drawing large currents from a battery. This can cause the battery and the entire system to heat up, often to an unsafe degree. For some electronic devices operated in close proximity to a user's skin, such as increasingly popular wearable devices, thermal runaway is a serious issue for human safety since the devices are often in direct contact with the skin (e.g. fingers, arms, chest, or face). In thermal runaway, temperatures can increase so rapidly that a user may not be able to react quickly enough to remove a device before suffering serious burns. In some cases, a wearable device in thermal runaway can cause third degree burns in less than 20 seconds.

### BRIEF DESCRIPTION OF THE DRAWINGS

Technology features and advantages will be apparent from the detailed description which follows, taken in conjunction with the accompanying drawings, which together illustrate, by way of example, various technology embodiments; and, wherein:

FIG. 1 illustrates a schematic representation of an electronic system in accordance with an example;

FIG. 2A illustrates a schematic representation of a thermally activated switch in an open position in accordance with an example;

FIG. 2B illustrates a schematic representation of the thermally activated switch of FIG. 2A in a closed position in accordance with an example;

FIGS. 3A and 3B illustrate operation of a switch as in FIGS. 2A and 2B with analytical calculations in accordance with an example;

FIG. 4A illustrates a schematic representation of a thermally activated switch in an open position in accordance with another example;

FIG. 4B illustrates a schematic representation of the thermally activated switch of FIG. 4A in a closed position in accordance with another example;

FIG. 5 illustrates a schematic representation of an electronic device package in accordance with an example;

FIG. 6 illustrates a schematic representation of an electronic device package in accordance with another example;

FIGS. 7A-7D illustrate a method for making a thermally activated switch in accordance with an example; and

FIGS. 8A-8D illustrate a method for making a thermally activated switch in accordance with another example.

Reference will now be made to the exemplary embodiments illustrated, and specific language will be used herein to describe the same. It will nevertheless be understood that no limitation of the scope or to specific invention embodiments is thereby intended.

### DESCRIPTION OF EMBODIMENTS

Before technology embodiments are disclosed and described, it is to be understood that no limitation to the particular structures, process steps, or materials disclosed herein is intended, but also includes equivalents thereof as would be recognized by those ordinarily skilled in the relevant arts. It should also be understood that terminology employed herein is used for describing particular examples only and is not intended to be limiting. The same reference numerals in different drawings represent the same element. Numbers provided in flow charts and processes are provided for clarity in illustrating steps and operations and do not necessarily indicate a particular order or sequence. Unless defined otherwise, all technical and scientific terms used herein have the same meaning as commonly understood by one of ordinary skill in the art to which this disclosure belongs.

As used in this written description, the singular forms “a,” “an” and “the” include express support for plural referents unless the context clearly dictates otherwise. Thus, for example, reference to “a component” includes a plurality of such components.

In this specification, “comprises,” “comprising,” “containing” and “having” and the like can have the meaning ascribed to them in U.S. patent law and can mean “includes,” “including,” and the like, and are generally interpreted to be open ended terms. The terms “consisting of” or “consists of” are closed terms, and include only the components, structures, steps, or the like specifically listed in conjunction with such terms, as well as that which is in accordance with U.S. patent law. “Consisting essentially of” or “consists essentially of” have the meaning generally ascribed to them by U.S. patent law. In particular, such terms are generally closed terms, with the exception of allowing inclusion of additional items, materials, components, steps, or elements, that do not materially affect the basic and novel characteristics or function of the item(s) used in connection therewith. For example, trace elements present in a composition, but not affecting the composition's nature or characteristics would be permissible if present under the “consisting essentially of” language, even though not expressly recited in a list of items following such terminology. When using an open ended term in the written description, like “comprising” or “including,” it is understood that direct support should be afforded also to “consisting essentially of” language as well as “consisting of” language as if stated explicitly and vice versa.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Similarly, if a method is described herein as comprising a series of steps, the order of such steps as presented herein is not necessarily the only order in which such steps may be performed, and certain of the stated steps may possibly be omitted and/or certain other steps not described herein may possibly be added to the method.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments described herein are, for example, capable of operation in other orientations than those illustrated or otherwise described herein. The term “coupled,” as used herein, is defined as directly or indirectly connected in an electrical or nonelectrical manner. Objects described herein as being “adjacent to” each other may be in physical contact with each other, in close proximity to each other, or in the same general region or area as each other, as appropriate for the context in which the phrase is used. Occurrences of the phrase “in one embodiment,” or “in one aspect,” herein do not necessarily all refer to the same embodiment or aspect.

As used herein, the term “substantially” refers to the complete or nearly complete extent or degree of an action, characteristic, property, state, structure, item, or result. For example, an object that is “substantially” enclosed would mean that the object is either completely enclosed or nearly completely enclosed. The exact allowable degree of deviation from absolute completeness may in some cases depend on the specific context. However, generally speaking the nearness of completion will be so as to have the same overall result as if absolute and total completion were obtained. The use of “substantially” is equally applicable when used in a negative connotation to refer to the complete or near complete lack of an action, characteristic, property, state, structure, item, or result. For example, a composition that is “substantially free of” particles would either completely lack particles, or so nearly completely lack particles that the effect would be the same as if it completely lacked particles. In other words, a composition that is “substantially free of” an ingredient or element may still actually contain such item as long as there is no measurable effect thereof.

As used herein, the term “about” when used in connection with a numerical value is used to provide flexibility and indicate that a given value may be “a little above” or “a little below” the specific numerical value. It is to be understood that in this written description, the occurrence of the term “about” with a numerical value also provides express support for the exact numerical value as though the term “about” were not present.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Concentrations, amounts, sizes, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 1 to about 5” should be interpreted to include not only the explicitly recited values of about 1 to about 5, but also include individual values and sub-ranges within the indicated range. Thus, included in this numerical range are individual values such as 2, 3, and 4 and sub-ranges such as from 1-3, from 2-4, and from 3-5, etc., as well as 1, 2, 3, 4, and 5, individually.

This same principle applies to ranges reciting only one numerical value as a minimum or a maximum. Furthermore, such an interpretation should apply regardless of the breadth of the range or the characteristics being described.

Reference throughout this specification to “an example” means that a particular feature, structure, or characteristic described in connection with the example is included in at least one embodiment. Thus, appearances of the phrases “in an example” in various places throughout this specification are not necessarily all referring to the same embodiment.

Furthermore, the described features, structures, or characteristics may be combined in any suitable manner in one or more embodiments. In this description, numerous specific details are provided, such as examples of layouts, distances, network examples, etc. One skilled in the relevant art will recognize, however, that many variations are possible without one or more of the specific details, or with other methods, components, layouts, measurements, etc. In other instances, well-known structures, materials, or operations are not shown or described in detail but are considered well within the scope of the disclosure.

### Example Embodiments

An initial overview of technology embodiments is provided below and specific technology embodiments are then described in further detail. This initial summary is intended to aid readers in understanding the technology more quickly but is not intended to identify key or essential features of the technology nor is it intended to limit the scope of the claimed subject matter.

Often, the temperature of an electronic device, such as a computing system, will rely on software to monitor the temperature of the CPU and the battery. Such software is designed to throttle power or turn the CPU off in order to maintain an acceptable temperature range. If the CPU is occupied by intensive calculation, however, this subroutine may not be executed in time to avoid thermal runaway. An alternative approach is to use an independent microcontroller and a temperature sensor to monitor the temperature and disconnect the system (e.g., the battery) if the temperature exceeds a certain level. This approach avoids the delay problem identified above with respect to running software, but due to complexity and size this approach increases the overall system cost and may present packaging difficulties.

Accordingly, thermally activated switches are disclosed that do not rely on software, can be easily constructed in a small size, and are cost-effective. In one aspect, a thermally activated switch as disclosed herein can be incorporated with or integrated into an electronic component, such as a semiconductor package. In one example, a thermally activated switch can include an electronic substrate base, and first and second electrical contacts coupled to the electronic substrate base. The first and second electrical contacts can be movable relative to one another due to thermal expansion or contraction of a material to facilitate contact or separation of the first and second electrical contacts. A movable electrical contact can be of any suitable configuration. For example, the switch can include first and second arms coupled to the electronic substrate base. The first and second arms can be coupled to opposite sides of a movable electrical contact and offset along a length of the movable electrical contact such that thermal expansion or contraction of the first and second arms causes the movable electrical contact to move. In another example, a movable electrical contact can comprise two materials having different coefficients of thermal expansion, such that thermal expansion or contraction of the two materials causes the movable electrical contact to move.

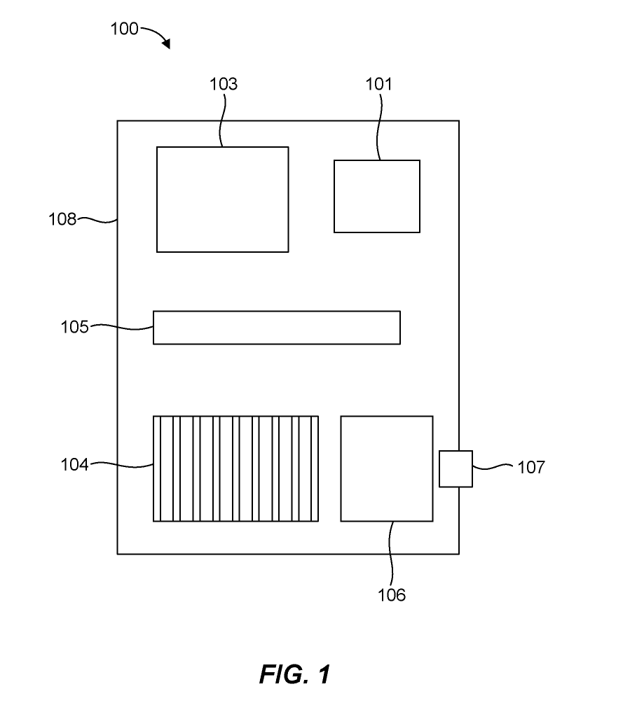

Referring to FIG. 1, an exemplary electronic system 100 is schematically illustrated. The electronic system 100 can be any suitable type of electronic system. For example, the electronic system 100 can comprise any type of computing system, such as a desktop computer, a laptop computer, a tablet computer, a smartphone, a server, a wearable device, etc. In general, the electronic system 100 includes a thermally activated switch 101 and a heat source 103. A heat source can be any self-generating source of heat and/or a component that is heated by another component (e.g., through thermal conduction) thereby serving as a source of heat for further heat transfer. In one aspect, the heat source 103 can comprise a processor and/or a battery. The electronic system 100 can further include a cooling system 104 (e.g., a heat sink and/or active cooling system), a processor, a memory device 105, a radio 106, a port 107, a slot, a battery, or any other suitable device or component of an electronic system. Any suitable device or component of the electronic system 100 can be configured as, or included in, a “package”, such as a semiconductor package. One or more of the devices or components of the electronic system 100 can be mounted on or otherwise associated with a substrate 108 (e.g., a motherboard). Other embodiments need not include all of the features specified in FIG. 1, and may include alternative features not specified in FIG. 1.

The thermally activated switch 101 can be configured to minimize or prevent negative effects caused by elevated temperatures (e.g., thermal runaway) of one or more system 100 components. For example, a battery and/or a processor have the potential to reach unsafe temperatures in certain operating conditions. In one aspect, the switch 101 can be configured to reduce or interrupt power from a battery and/or reduce or interrupt power to a processor if a predetermined temperature or temperature range is detected, which may be indicative of a potential thermal runaway condition. In another aspect, the switch 101 can be configured to activate an active cooling system (e.g., a thermoelectric cooler) configured to cool the heat source 103, such as a battery and/or a processor.

The switch 101 can be electrically coupled to, or incorporated with, any suitable system 100 component in any suitable manner to accomplish the objectives described above. In one aspect, the switch 101 can short circuit (e.g., shunt current around a processor) or disconnect a circuit providing power to or from the heat source 103. In another aspect, the switch 101 can be included in a circuit that is independent of power to or from the heat source 103, but can nevertheless influence temperature of the heat source. For example, the switch 101 can be configured to reset a processor or activate a thermal shut-off switch.

In addition to providing switch functionality, the switch 101 can provide temperature sensing functionality, as described in more detail below. Thus, the switch 101 can be located on, or in contact with, the heat source 103 or component being heated or monitored (e.g., close to a battery, CPU, etc.). In one aspect, the switch 101 can be configured to be located near a user's skin, such as at an interface between the system 100 and the user, to effectively monitor skin temperature and protect against burns.

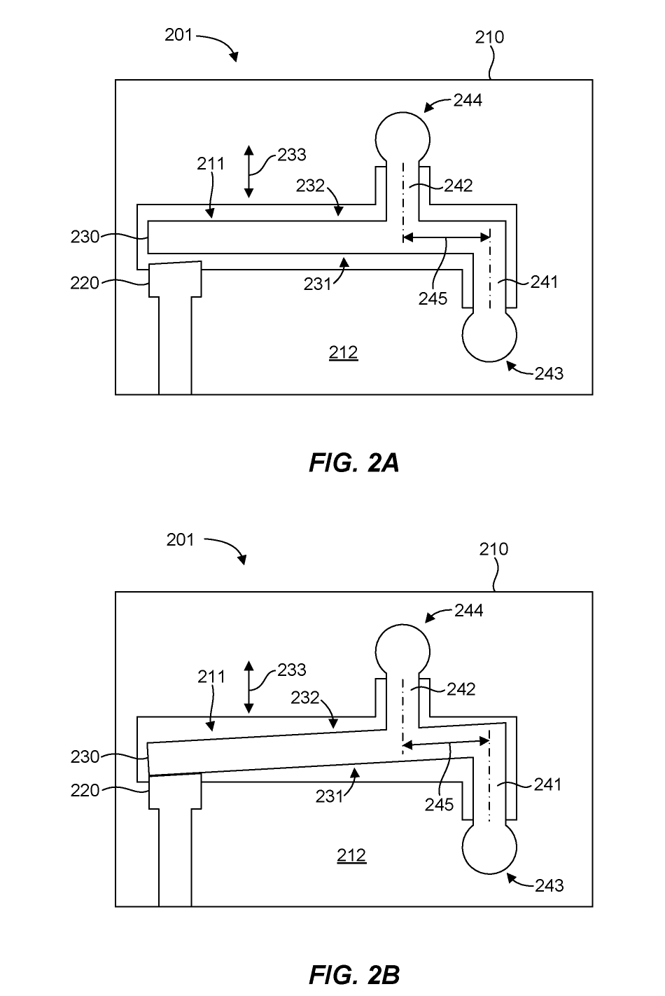

FIGS. 2A and 2B illustrate a thermally activated switch 201 in accordance with an example of the present disclosure. The switch 201 can include a base 210, a fixed electrical contact 220 coupled to the base 210, and a movable electrical contact 230 coupled to the base 210. The switch 201 can also include first and second arms 241, 242 coupled to the base 210 and to the movable electrical contact 230. The first and second arms 241, 242 can include anchor portions 243, 244, respectively, to mechanically and/or electrically couple the arms to the base 210. The first and second arms 241, 242 can be coupled to the movable electrical contact 230 in any suitable manner. In one aspect, the first arm 241 and/or the second arm 242 can be integrally formed with the movable electrical contact 230. The fixed electrical contact 220 and the movable electrical contact 230 can be electrically coupleable to an electronic circuit (not shown). In one aspect, the first arm 241 and/or the second arm 242 can be electrically coupleable to an electronic circuit in order to couple the movable electrical contact 230 to the electronic circuit.

The movable electrical contact 230 can be movable relative to the fixed electrical contact 220 due to thermal expansion or contraction of a material to facilitate contact or separation of the fixed and movable electrical contacts. For example, the first arm 241 and the second arm 242 can be coupled to opposite sides 231, 232, respectively, of the movable electrical contact 230 and offset 245 along a length of the movable electrical contact 230 such that thermal expansion or contraction of the first and second arms 241, 242 causes the movable electrical contact 230 to move (compare FIG. 2A open position and FIG. 2B closed position).

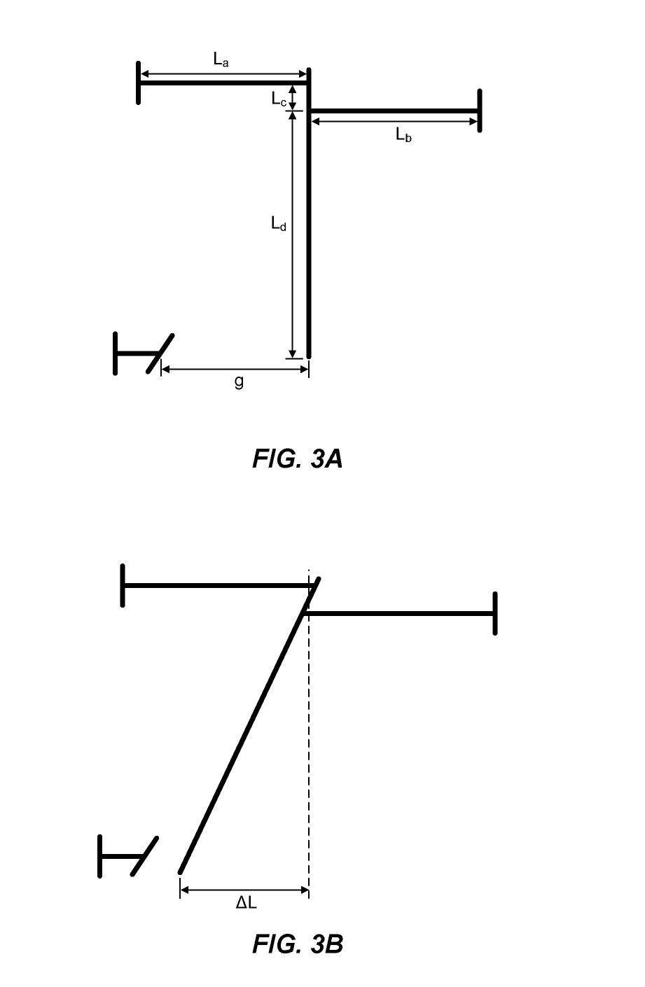

FIGS. 3A and 3B illustrate the operation of a switch as in FIGS. 2A and 2B with analytical calculations for an example embodiment. Displacement ΔL of a movable electrical contact for a change in temperature ΔT is given by: ΔL=(1+L_{d}/L_{c})×(Lₐ+L_{b})×α×ΔT. For L_{d}=1 mm, L_{c}=40 μm, Lₐ=L_{b}=0.5 mm, ΔT=30° C., and coefficient of thermal expansion (CTE) α=16.6×10⁻⁶ m/m/° C., the resulting ΔL=12.9 μm. The gap g is the distance between fixed and movable electrical contacts. To ensure that the switch can close, g≦ΔL. For this switch configuration, material, and ΔT, g≦12.9 μm. With its sensitivity to changes in temperature, a switch as disclosed herein can provide temperature sensing functionality in addition to providing switch functionality for an electrical circuit. It should be recognized that the dimensions in this example are provided merely for illustrative purposes and that a switch in accordance with the present disclosure can have any suitable dimensions and material properties, and can be designed for operation at any suitable temperature or temperature range. The only limits on switch size may be the practical considerations of space constraints and/or manufacturing capabilities.

With further reference to FIGS. 2A and 2B, it can be seen that the switch 201 is configured to close at a relatively high temperature and re-open when the temperature drops. Thus, for example, at room temperature the movable electrical contact 230 would not make contact with the fixed electrical contact 220. At higher temperatures, the arms 241, 242 anchored to the base 210 expand causing the movable electrical contact 230 to move and make contact with the fixed electrical contact 220. Alternatively, a switch can be configured to be closed at relatively lower temperatures and to open at a higher temperature, reclosing when the temperature drops sufficiently. In such a switch configuration, for example, the fixed electrical contact 220 can be located on the side 232 of the movable electrical contact 230, instead of being located on the side 231 as shown in FIGS. 2A and 2B.

In one aspect, the switch 201 can include a recess 211 in the base 210. The movable electrical contact 230 can be suspended over the recess 211 by the first and second arms 241, 242 to facilitate movement of the movable electrical contact 230. In other words, the movable electrical contact 230 suspended over the recess 211 is clear of obstructions or friction and is therefore free to move as the temperature changes. In one aspect, the fixed electrical contact 220, the first arm 241, and/or the second arm 242 can be disposed at least partially on a top surface 212 of the base 210. The movable electrical contact 230 can be configured to move in a direction 233 parallel to the top surface 212 of the base 210, which can be planar.

In one aspect, the base 210 can comprise an electronic substrate, such as a package substrate or a motherboard. Thus, in one embodiment, the first arm 241 and/or the second arm 242 can be coupled to the base (e.g., an electronic substrate) by a via, such as is commonly found in electronic substrates. For example, vias extending into the substrate base 210 from the top surface 212 can form the anchor portions 243, 244 of the arms. In one aspect, such vias can be electrically coupleable to an electronic circuit, such as by one or more traces (not shown) located in or on the substrate base 210. Thus, some embodiments of the present disclosure provide a thermally activated switch that is integrated or otherwise associated with an electronic substrate (e.g., semiconductor packaging or motherboard) or other suitable substrate. Such switches can be configured to occupy a small area in an electronic system and can provide a secure and cost effective way to detect and minimize or prevent thermal runaway. The present technology can therefore be useful for small form factor devices.

Although the thermally activated switch of FIGS. 2A and 2B is discussed in terms of a fixed electrical contact and a movable electrical contact, it should be recognized that a similar thermally activated switch in accordance with the present disclosure can include two movable electrical contacts. In this case, two electrical contacts are both movable due to thermal expansion or contraction of a material to facilitate contact or separation of the electrical contacts.

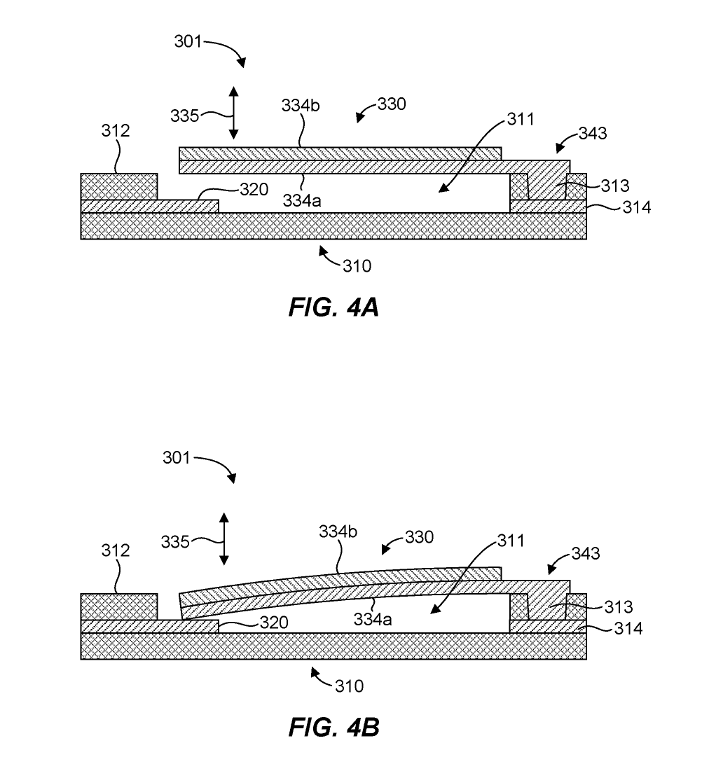

FIGS. 4A and 4B illustrate cross-sectional views of a thermally activated switch 301 in accordance with another example of the present disclosure. The switch 301 can include a base 310, a fixed electrical contact 320 coupled to the base 310, and a movable electrical contact 330 coupled to the base 310. The movable electrical contact 330 can include an anchor portion 343 to couple the movable electrical contact 330 to the base 310. The fixed electrical contact 320 and the movable electrical contact 330 can be electrically coupleable to an electronic circuit (not shown). In one aspect, the movable electrical contact 330 can be electrically coupleable to an electronic circuit by the anchor portion 343.

The movable electrical contact 330 can be movable relative to the fixed electrical contact 320 due to thermal expansion or contraction of a material to facilitate contact or separation of the fixed and movable electrical contacts. In this case, the movable electrical contact 330 comprises two materials 334a, 334b having different coefficients of thermal expansion (e.g., a bimetallic strip), such that thermal expansion or contraction of the two materials causes the movable electrical contact 330 to move (compare FIG. 4A open position and FIG. 4B closed position). For example, the switch 301 can be configured to close at a relatively high temperature and re-open when the temperature drops. In this case, at room temperature the movable electrical contact 330 would not make contact with the fixed electrical contact 320 (FIG. 4A). The material 334a can have a lower CTE than the material 334b of the movable electrical contact 330. Thus, at higher temperatures the material 334b will expand more than the material 334a of the movable electrical contact 330 causing the movable electrical contact 330 to move and make contact with the fixed electrical contact 320 (FIG. 4B). Alternatively, the switch 301 can be configured to be closed at relatively lower temperatures and to open at a higher temperature, reclosing when the temperature drops sufficiently. In such a switch configuration, the material 334a can have a higher CTE than the material 334b of the movable electrical contact 330. Thus, at higher temperatures the material 334a will expand more than the material 334b of the movable electrical contact 330 causing the movable electrical contact 330 to move away from the fixed electrical contact 320.

The materials 334a, 334b of the movable electrical contact 330 can be any suitable materials that have different CTE, with at least one of the materials being electrically conductive to facilitate switch functionality of the switch 301. For example, the materials 334a, 334b can both comprise metals having different CTE (e.g., copper and nickel) to form a bimetallic strip. In another example, one of the materials can comprise a metal and the other material can comprise a non-metal (e.g., a relatively stiff material with an appropriate thermal expansion coefficient). In yet another example, the materials can each comprise non-metals but still be electrically conductive (e.g. a conductive polymer or a dielectric coated with a thin conductive layer). Thus, any suitable material can be utilized in the movable electrical contact 330 in any suitable combination.

In one aspect, the switch 301 can include a recess 311 in the base 310. The movable electrical contact 330 can be at least partially suspended over the recess 311 to facilitate movement of the movable electrical contact 330 by providing a region about the movable electrical contact that is clear of obstructions so that the movable electrical contact is free to move as the temperature changes. In one aspect, the movable electrical contact 330 can be coupled to the base 310 outside of the recess 311 (e.g., to a top surface 312 of the base 310) and the fixed electrical contact 320 can be disposed in the recess 311. Thus, the movable electrical contact 330 can be configured to move at least partially within the recess 311. In the illustrated example, the movable electrical contact 330 is configured to move in a direction 335 perpendicular to the top surface 312 of the base 310, which can be planar. It should be recognized, however, that the movable electrical contact 330 can be configured to move in a direction parallel to the top surface 312. This can be accomplished by locating the fixed electrical contact 320 and the movable electrical contact 330 in a common plane parallel to the top surface 312, such as by locating the fixed electrical contact 320 and the movable electrical contact 330 on the top surface 312.

In the illustrated embodiment, the movable electrical contact 330 comprises a linear configuration and is cantilevered from the base 310 (e.g., from the anchor portion 343). It should be recognized that the movable electrical contact 330 can be coupled to or supported about the base 310 in any suitable manner. For example, the movable electrical contact 330 be fixed to the base 310 at opposite ends. In addition, the movable electrical contact can have any suitable configuration. For example, the movable electrical contact can comprise a spiral configuration, a helical configuration, or any other suitable configuration designed to enhance or increase deformation or movement of the movable electrical contact with temperature changes, which can facilitate a reduction in size of the movable electrical contact, if desired. In some embodiments, the movable electrical contact can have a tip configured or shaped to facilitate an electrical interface with the fixed electrical contact, such as by being angled or bent toward the fixed electrical contact.

Although the thermally activated switch of FIGS. 4A and 4B is discussed in terms of a fixed electrical contact and a movable electrical contact, it should be recognized that a similar thermally activated switch in accordance with the present disclosure can include two movable electrical contacts. In this case, two electrical contacts are both movable due to thermal expansion or contraction of a material to facilitate contact or separation of the electrical contacts.

In one aspect, the base 310 can comprise an electronic substrate, such as a package substrate or a motherboard. Thus, in one embodiment, the movable electrical contact 330 can be coupled to the base (e.g., an electronic substrate) by a via, such as is commonly found in electronic substrates. For example, a via 313 extending into the substrate base 310 from the top surface 312 can at least partially form the anchor portion 343 of the movable electrical contact 330. In one aspect, the via 313 can be electrically coupleable to an electronic circuit, such as by a trace 314 located in or on the substrate base 310. Thus, some embodiments of the present disclosure provide a thermally activated switch that is integrated or otherwise associated with an electronic substrate (e.g., semiconductor packaging or motherboard) or other suitable substrate. Such switches can be configured to occupy a small area in an electronic system and can provide a secure and cost effective way to detect and minimize or prevent thermal runaway. The present technology can therefore be useful for small form factor devices.

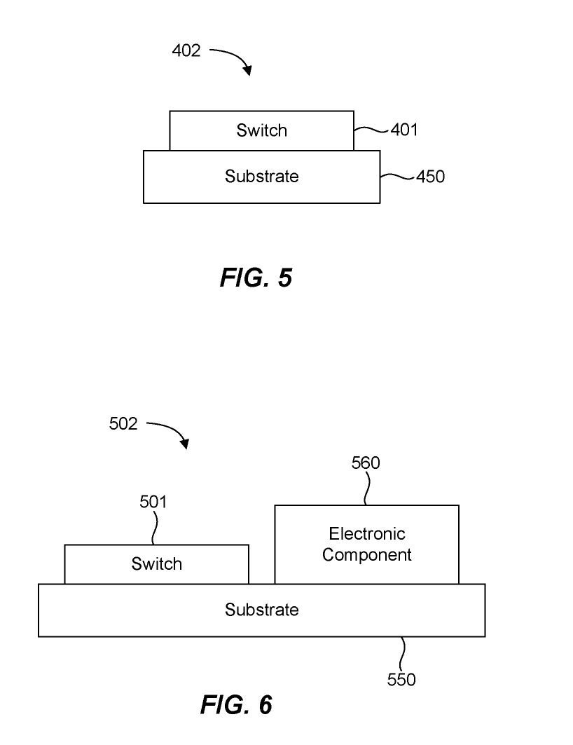

For example, FIG. 5 schematically illustrates an electronic device package 402. The package 402 includes a package substrate 450 and a thermally activated switch 401 as described herein associated with the package substrate. As mentioned above, the package substrate 450 can comprises a base of the switch 401. The switch 401 can optionally include a base separate and distinct from the package substrate 450. In either case, the switch 401 can be configured as a package and attached to a substrate, such as a motherboard, for connection to an electrical circuit.

FIG. 6 schematically illustrates a further example of this concept. In this case, a package 502 not only includes a switch 501 as disclosed herein associated with a package substrate 550, but the package 502 also includes an electronic component 560 disposed on the package substrate. The electronic component 560 can be any electronic device or component that may be included in an electronic device package, such as a semiconductor device (e.g., a die, a chip, or a processor). Thus, the switch 501 can be integrated with one or more components typically found in a semiconductor package. In one aspect, the electronic component 560 can comprise a heat source, such as a processor. The switch 501 can therefore be disposed in close proximity to the heat source in the package 502 to facilitate sensing changes in temperature in the heat source. In another aspect, the switch 501 can be electrically coupled to the heat source, as described above, and configured to reduce or disconnect power to the heat source in the event of a thermal runaway. The switch 501 can optionally be electrically connected to an active cooling system external to the package 502 to initiate cooling of the heat source when a thermal runaway or other temperature change has been detected.

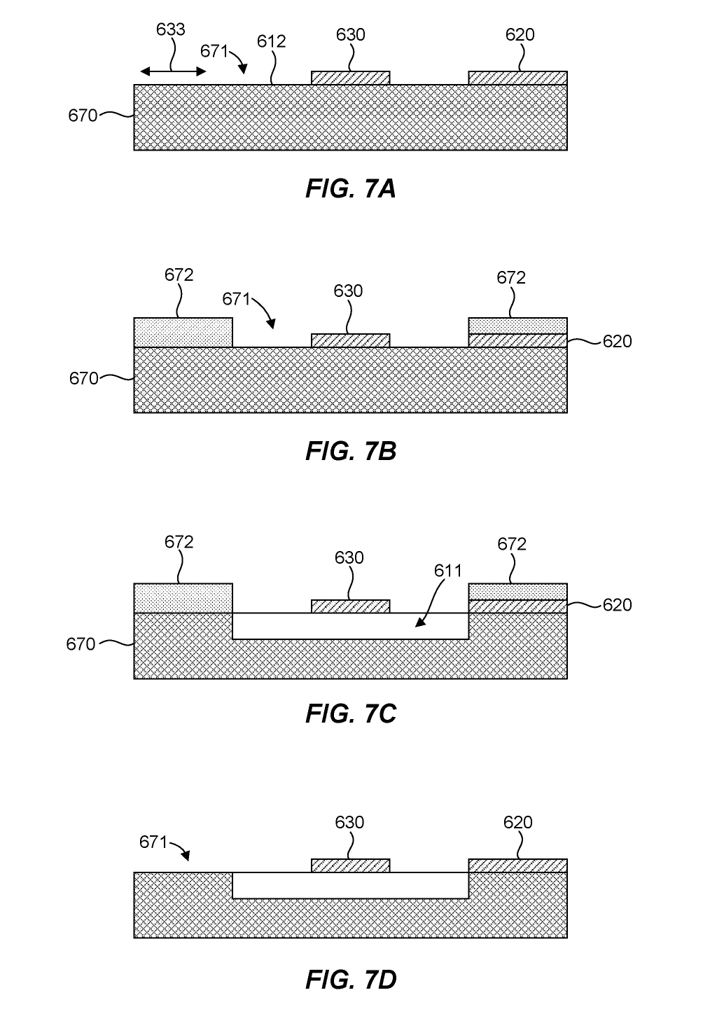

FIGS. 7A-7D illustrate aspects of an exemplary method or process for making a thermally activated switch as disclosed herein, which can be integrated in a package or PCB with a few extra processing steps. For example, a substrate can be fabricated using standard semi-additive or subtractive process until the last metal layer. FIG. 7A illustrates forming a fixed electrical contact 620 and a movable electrical contact 630 on a dielectric or an insulating layer 670 of a substrate 671. The fixed and movable electrical contacts 620, 630 can be formed in any suitable manner, such as by depositing conductive material on the dielectric layer and/or removing material from a conductive layer disposed on the dielectric layer such that a portion of the conductive layer forms the fixed and/or movable electrical contact.

The movable electrical contact 630 can be formed such that it is movable relative to the fixed electrical contact 620 due to thermal expansion or contraction of a material to facilitate contact or separation of the fixed and movable electrical contacts. In this example, the movable electrical contact 630 is configured to move in a direction 633 parallel to a top surface 612 of the substrate 671. In one embodiment, the first and second arms (as described herein with respect to FIGS. 2A and 2B but not shown in FIGS. 7A-7D) can be formed in a similar manner as the fixed and movable electrical contacts. The first and second arms can be coupled to opposite sides of the movable electrical contact and offset along a length of the movable electrical contact such that thermal expansion or contraction of the first and second arms causes the movable electrical contact to move. In one aspect, the first and second arms can be integrally formed with the movable electrical contact. With regard to the embodiment described with respect to FIGS. 4A and 4B, the movable electrical contact can comprise two materials having different coefficients of thermal expansion, such that thermal expansion or contraction of the two materials causes the movable electrical contact to move. One material can be deposited on the substrate 671 and/or can come from a conductive layer already disposed on the dielectric layer 670, as described above. The other material can be associated with the first material in any suitable manner, such as electroplating a metal, paste printing a metal (e.g. a solder paste), etc.

FIGS. 7B and 7C illustrate forming a recess 611 (FIG. 7C) in the dielectric layer 670 proximate the movable electrical contact 630, which can suspend the movable electrical contact across the recess 611 by the first and second arms. In particular, FIG. 7B illustrates a reactive ion etch (RIE) resist mask 672 disposed over the substrate 671 in the areas where it is desired to etch away the substrate to form the recess 611. The substrate 671 can then be placed in a RIE etch tool to remove the build-up film material in the exposed areas to form the recess 611, as shown in FIG. 7C. FIG. 7D shows the RIE mask removed from the substrate 671 to complete fabrication of the switch portion of the package. Additional process steps typical of electronic device package fabrication (e.g., solder resist deposition and surface finish) can also be performed as desired. In one aspect, a via can be formed in the substrate to couple a first arm and/or a second arm to the substrate 671. Although RIE resist mask technology is used as an example, it should be recognized that the recess 611 can be formed utilizing any suitable technique or method, such as a photolithographic process, a laser removal process, etc. In addition, certain components of the switch can be fabricated separately and assembled to form the switch. For example, metal components, such as the fixed and movable electrical contacts, can be made separate from a substrate or base and coupled to the substrate or base in a subsequent operation.

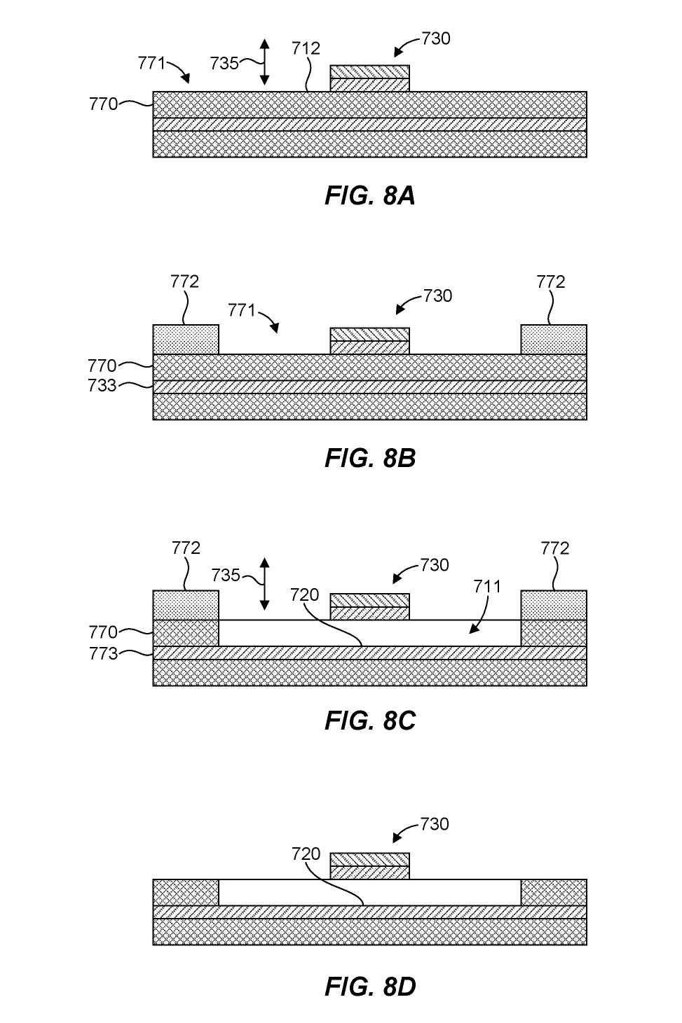

FIGS. 8A-8D illustrate aspects of another exemplary method or process for making a thermally activated switch as disclosed herein, which can also be integrated in a package or PCB with a few extra processing steps, as with the example discussed above with respect to FIGS. 7A-7D. In this example, a movable electrical contact 730 is configured to move in a direction 735 perpendicular to a top surface 712 of a substrate 771. FIG. 8A illustrates forming a movable electrical contact 730 on a dielectric layer 770 of the substrate 771. The movable electrical contact 730 can be formed in any suitable manner, such as by depositing conductive material on the dielectric layer and/or removing material from a conductive layer disposed on the dielectric layer such that a portion of the conductive layer forms the movable electrical contact. The movable electrical contact 730 can be formed such that it is movable relative to the fixed electrical contact 720 (in FIG. 8D) due to thermal expansion or contraction of a material to facilitate contact or separation of the fixed and movable electrical contacts. For example, with regard to the embodiment described with respect to FIGS. 4A and 4B, the movable electrical contact can comprise two materials having different coefficients of thermal expansion, such that thermal expansion or contraction of the two materials causes the movable electrical contact to move. One material can be deposited on the substrate 771 and/or can come from a conductive layer already disposed on the dielectric layer 770, as described above. The other material can be associated with the first material in any suitable manner, such as electroplating a metal, paste printing a metal (e.g. a solder paste), etc.

FIGS. 8B and 8C illustrate forming a fixed electrical contact 720 proximate the dielectric layer 770. This can be accomplished by forming a recess 711 in the dielectric layer 770 between the movable electrical contact 730 and a conductive layer 773 proximate the dielectric layer, such that a portion of the conductive layer 773 forms the fixed electrical contact 720 in the recess 711. In particular, FIG. 8B illustrates an RIE resist mask 772 disposed over the substrate 771 in the areas where it is desired to etch away the substrate to form the recess 711. The substrate 771 can then be placed in a RIE etch tool to remove the build-up film material in the exposed areas to form the recess 711, as shown in FIG. 8C. With a portion of the dielectric layer 770 removed adjacent to a portion of the conductive layer 773, the movable electrical contact 730 can move in direction 735 relative to the fixed electrical contact 720. FIG. 8D shows the RIE mask removed from the substrate 771 to complete fabrication of the switch portion of the package. Additional process steps typical of electronic device package fabrication (e.g., solder resist deposition and surface finish) can also be performed as desired. In one aspect, a via can be formed in the substrate to couple or anchor the movable electrical contact 730 to the substrate 771. Although RIE resist mask technology is used as an example, it should be recognized that the recess 711 can be formed utilizing any suitable technique or method, such as a photolithographic process, a laser removal process, etc. In addition, certain components of the switch can be fabricated separately and assembled to form the switch. For example, metal components, such as the movable electrical contact, can be made separate from a substrate or base and coupled to the substrate or base in a subsequent operation.

### Examples

The following examples pertain to further embodiments.

In one example there is provided a thermally activated switch comprising an electronic substrate base, and first and second electrical contacts coupled to the electronic substrate base, wherein the first and second electrical contacts are movable relative to one another due to thermal expansion or contraction of a material to facilitate contact or separation of the first and second electrical contacts.

In one example of a thermally activated switch, the first electrical contact is a fixed electrical contact and the second electrical contact is a movable electrical contact.

In one example, a thermally activated switch further comprises a first arm coupled to the electronic substrate base, and a second arm coupled to the electronic substrate base, wherein the first and second arms are coupled to opposite sides of the movable electrical contact and offset along a length of the movable electrical contact such that thermal expansion or contraction of the first and second arms causes the movable electrical contact to move.

In one example, a thermally activated switch further comprises a recess in the electronic substrate base, wherein the movable electrical contact is suspended over the recess by the first and second arms to facilitate movement of the movable electrical contact.

In one example of a thermally activated switch, at least one of the fixed electrical contact, the first arm, and the second arm is disposed at least partially on a top surface of the electronic substrate base.

In one example of a thermally activated switch, the movable electrical contact is configured to move in a direction parallel to a planar top surface of the electronic substrate base.

In one example of a thermally activated switch, the first arm, the second arm, and the movable electrical contact are integrally formed with one another.

In one example of a thermally activated switch, the fixed electrical contact and at least one of the first arm and the second arm are electrically coupleable to an electronic circuit.

In one example of a thermally activated switch, at least one of the first arm and the second arm is coupled to the electronic substrate base by a via.

In one example of a thermally activated switch, the via is electrically coupleable to an electronic circuit.

In one example of a thermally activated switch, the movable electrical contact comprises two materials having different coefficients of thermal expansion, such that thermal expansion or contraction of the two materials causes the movable electrical contact to move.

In one example of a thermally activated switch, the movable electrical contact is cantilevered from the electronic substrate base.

In one example of a thermally activated switch, the movable electrical contact is configured to move in a direction perpendicular to a planar top surface of the electronic substrate base.

In one example of a thermally activated switch, the movable electrical contact comprises a linear configuration.

In one example, a thermally activated switch further comprises a recess in the electronic substrate base, wherein the movable electrical contact is configured to move at least partially within the recess.

In one example of a thermally activated switch, the fixed electrical contact is disposed in the recess.

In one example of a thermally activated switch, the movable electrical contact is coupled to the electronic substrate base outside of the recess.

In one example of a thermally activated switch, the movable electrical contact is coupled to the electronic substrate base by a via.

In one example of a thermally activated switch, the via is electrically coupleable to an electronic circuit.

In one example there is provided a thermally activated switch comprising a base, a fixed electrical contact coupled to the base, a first arm coupled to the base, a second arm coupled to the base, and a movable electrical contact coupled to the first and second arms, wherein the first and second arms are coupled to opposite sides of the movable electrical contact and offset along a length of the movable electrical contact such that thermal expansion or contraction of the first and second arms causes the movable electrical contact to move relative to the fixed electrical contact thereby facilitating contact or separation of the fixed and movable electrical contacts.

In one example, a thermally activated switch further comprises a recess in the base, wherein the movable electrical contact is suspended over the recess by the first and second arms to facilitate movement of the movable electrical contact.

In one example of a thermally activated switch, at least one of the fixed electrical contact, the first arm, and the second arm is disposed at least partially on a top surface of the base.

In one example of a thermally activated switch, the movable electrical contact is configured to move in a direction parallel to a planar top surface of the base.

In one example of a thermally activated switch, the first arm, the second arm, and the movable electrical contact are integrally formed with one another.

In one example of a thermally activated switch, the fixed electrical contact and at least one of the first arm and the second arm are electrically coupleable to an electronic circuit.

In one example of a thermally activated switch, the base comprises an electronic substrate.

In one example of a thermally activated switch, at least one of the first arm and the second arm is coupled to the electronic substrate by a via.

In one example of a thermally activated switch, the via is electrically coupleable to an electronic circuit.

In one example there is provided a thermally activated switch comprising a base, a fixed electrical contact coupled to the base, and a movable electrical contact coupled to the base, the movable electrical contact including two materials having different coefficients of thermal expansion, such that thermal expansion or contraction of the two materials causes the movable electrical contact to move relative to the fixed electrical contact thereby facilitating contact or separation of the fixed and movable electrical contacts.

In one example of a thermally activated switch, the movable electrical contact is cantilevered from the base.

In one example of a thermally activated switch, the movable electrical contact is configured to move in a direction perpendicular to a planar top surface of the electronic substrate base.

In one example of a thermally activated switch, the movable electrical contact comprises a linear configuration.

In one example, a thermally activated switch further comprises a recess in the base, wherein the movable electrical contact is configured to move at least partially within the recess.

In one example of a thermally activated switch, the fixed electrical contact is disposed in the recess.

In one example of a thermally activated switch, the movable electrical contact is coupled to the base outside of the recess.

In one example of a thermally activated switch, the base comprises an electronic substrate.

In one example of a thermally activated switch, the movable electrical contact is coupled to the electronic substrate by a via.

In one example of a thermally activated switch, the via is electrically coupleable to an electronic circuit.

In one example there is provided an electronic device package comprising a package substrate, and a thermally activated switch as disclosed herein associated with the package substrate.

In one example of an electronic device package, the package substrate comprises the base.

In one example, an electronic device package further comprises an electronic component disposed on the package substrate.

In one example of an electronic device package, the electronic component comprises a heat source.

In one example of an electronic device package, the heat source comprises a processor.

In one example there is provided an electronic system comprising a heat source, a substrate, and a thermally activated switch as disclosed herein associated with the substrate.

In one example of an electronic system, the substrate comprises the base.

In one example of an electronic system, the heat source comprises a battery.

In one example of an electronic system, the thermally activated switch is configured to reduce power from the battery.

In one example of an electronic system, the thermally activated switch is configured to interrupt power from the battery.

In one example of an electronic system, the heat source comprises a processor.

In one example of an electronic system, the thermally activated switch is configured to reduce power to the processor.

In one example of an electronic system, the thermally activated switch is configured to interrupt power to the processor.

In one example, an electronic system further comprises an active cooling system configured to cool the heat source, wherein the thermally activated switch is configured to activate the active cooling system.

In one example of an electronic system, the substrate comprises a motherboard.

In one example, an electronic system further comprises a processor, a memory device, a radio, a slot, a port, or a combination thereof operably coupled to the motherboard.

In one example, an electronic system comprises a computing system.

In one example of an electronic system, the computing system comprises a desktop computer, a laptop, a tablet, a smartphone, a server, a wearable device, or a combination thereof.

In one example there is provided a method for making a thermally activated switch comprising obtaining a substrate having a dielectric layer, forming a first electrical contact proximate the dielectric layer, and forming a second electrical contact on the dielectric layer, such that the second electrical contact is second relative to the first electrical contact due to thermal expansion or contraction of a material to facilitate contact or separation of the first and second electrical contacts.

In one example of a method for making a thermally activated switch, forming a second electrical contact on the dielectric layer comprises depositing conductive material on the dielectric layer.

In one example of a method for making a thermally activated switch, forming a second electrical contact on the dielectric layer comprises removing material from a conductive layer disposed on the dielectric layer, such that a portion of the conductive layer forms the second electrical contact.

In one example of a method for making a thermally activated switch, forming a first electrical contact proximate the dielectric layer comprises depositing conductive material on the dielectric layer.

In one example of a method for making a thermally activated switch, forming a first electrical contact proximate the dielectric layer comprises removing material from a conductive layer disposed on the dielectric layer, such that a portion of the conductive layer forms the first electrical contact.

In one example of a method for making a thermally activated switch, forming a first electrical contact proximate the dielectric layer comprises forming a recess in the dielectric layer between the second electrical contact and a conductive layer proximate the dielectric layer, such that a portion of the conductive layer forms the first electrical contact in the recess.

In one example of a method for making a thermally activated switch, forming a recess in the dielectric layer comprises a photolithographic process, a laser removal process, or a combination thereof.

In one example, a method for making a thermally activated switch further comprises forming a first arm coupled to the substrate, and forming a second arm coupled to the substrate, wherein the first and second arms are coupled to opposite sides of the second electrical contact and offset along a length of the second electrical contact such that thermal expansion or contraction of the first and second arms causes the second electrical contact to move.

In one example of a method for making a thermally activated switch, the first and second arms are integrally formed with the second electrical contact.

In one example, a method for making a thermally activated switch further comprises forming a recess in the dielectric layer proximate the second electrical contact, wherein the second electrical contact is suspended across the recess by the first and second arms.

In one example, a method for making a thermally activated switch further comprises forming a via in the substrate to couple at least one of the first arm and the second arm to the substrate.

In one example of a method for making a thermally activated switch, the second electrical contact comprises two materials having different coefficients of thermal expansion, such that thermal expansion or contraction of the two materials causes the second electrical contact to move.

In one example, a method for making a thermally activated switch further comprises forming a via in the substrate to couple the second electrical contact to the substrate.

In one example of a method for making a thermally activated switch, the second electrical contact is cantilevered from the substrate.

In one example of a method for making a thermally activated switch, the second electrical contact comprises a linear configuration.

Circuitry used in electronic components or devices (e.g. a die) of an electronic device package can include hardware, firmware, program code, executable code, computer instructions, and/or software. Electronic components and devices can include a non-transitory computer readable storage medium which can be a computer readable storage medium that does not include signal. In the case of program code execution on programmable computers, the computing devices recited herein may include a processor, a storage medium readable by the processor (including volatile and non-volatile memory and/or storage elements), at least one input device, and at least one output device. Volatile and non-volatile memory and/or storage elements may be a RAM, EPROM, flash drive, optical drive, magnetic hard drive, solid state drive, or other medium for storing electronic data. Node and wireless devices may also include a transceiver module, a counter module, a processing module, and/or a clock module or timer module. One or more programs that may implement or utilize any techniques described herein may use an application programming interface (API), reusable controls, and the like. Such programs may be implemented in a high level procedural or object oriented programming language to communicate with a computer system. However, the program(s) may be implemented in assembly or machine language, if desired. In any case, the language may be a compiled or interpreted language, and combined with hardware implementations.

While the forgoing examples are illustrative of the specific embodiments in one or more particular applications, it will be apparent to those of ordinary skill in the art that numerous modifications in form, usage and details of implementation can be made without departing from the principles and concepts articulated herein.

What is claimed is:

1. A thermally activated switch, comprising:
an electronic substrate base; and
first and second electrical contacts coupled to the electronic substrate base, wherein the first and second electrical contacts are movable relative to one another due to thermal expansion or contraction of a material to facilitate contact or separation of the first and second electrical contacts.

2. The thermally activated switch of claim 1, wherein the first electrical contact is a fixed electrical contact and the second electrical contact is a movable electrical contact.

3. The thermally activated switch of claim 2, further comprising:
a first arm coupled to the electronic substrate base; and
a second arm coupled to the electronic substrate base,
wherein the first and second arms are coupled to opposite sides of the movable electrical contact and offset along a length of the movable electrical contact such that thermal expansion or contraction of the first and second arms causes the movable electrical contact to move.

4. The thermally activated switch of claim 3, further comprising a recess in the electronic substrate base, wherein the movable electrical contact is suspended over the recess by the first and second arms to facilitate movement of the movable electrical contact.

5. The thermally activated switch of claim 3, wherein at least one of the fixed electrical contact, the first arm, and the second arm is disposed at least partially on a top surface of the electronic substrate base.

6. The thermally activated switch of claim 3, wherein the movable electrical contact is configured to move in a direction parallel to a planar top surface of the electronic substrate base.

7. The thermally activated switch of claim 3, wherein the first arm, the second arm, and the movable electrical contact are integrally formed with one another.

8. The thermally activated switch of claim 3, wherein the fixed electrical contact and at least one of the first arm and the second arm are electrically coupleable to an electronic circuit.

9. The thermally activated switch of claim 3, wherein at least one of the first arm and the second arm is coupled to the electronic substrate base by a via.

10. The thermally activated switch of claim 9, wherein the via is electrically coupleable to an electronic circuit.

11. The thermally activated switch of claim 2, wherein the movable electrical contact comprises two materials having different coefficients of thermal expansion, such that thermal expansion or contraction of the two materials causes the movable electrical contact to move.

12. The thermally activated switch of claim 11, wherein the movable electrical contact is cantilevered from the electronic substrate base.

13. The thermally activated switch of claim 11, wherein the movable electrical contact is configured to move in a direction perpendicular to a planar top surface of the electronic substrate base.

14. The thermally activated switch of claim 11, wherein the movable electrical contact comprises a linear configuration.

15. The thermally activated switch of claim 11, further comprising a recess in the electronic substrate base, wherein the movable electrical contact is configured to move at least partially within the recess.

16. The thermally activated switch of claim 15, wherein the fixed electrical contact is disposed in the recess.

17. The thermally activated switch of claim 15, wherein the movable electrical contact is coupled to the electronic substrate base outside of the recess.

18. The thermally activated switch of claim 11, wherein the movable electrical contact is coupled to the electronic substrate base by a via.

19. The thermally activated switch of claim 18, wherein the via is electrically coupleable to an electronic circuit.

20. An electronic system, comprising:
a heat source;
a substrate; and
a thermally activated switch as in any one of claims 1-38 associated with the substrate.

21. The electronic system of claim 20, wherein the substrate comprises the base.

22. The electronic system of claim 20, wherein the heat source comprises a battery.

23. The electronic system of claim 20, wherein the heat source comprises a processor.

24. The electronic system of claim 20, further comprising an active cooling system configured to cool the heat source, wherein the thermally activated switch is configured to activate the active cooling system.

25. The electronic system of claim 20, wherein the substrate comprises a motherboard.

26. The electronic system of claim 20, wherein the electronic system comprises a computing system.
